(19) United States
(12) Patent Application Publication
(10) Pub. No.: US 2014/0087786 A1
(43) Pub. Date: Mar. 27, 2014

(54) COMMUNICATION EQUIPMENT AND ELECTRONIC EQUIPMENT

(71) Applicant: PANASONIC CORPORATION, Osaka (JP)

(72) Inventors: Kazuya TANI, Osaka (JP); Toshiaki ICHIMARU, Osaka (JP); Akira ITOU, Kyoto (JP)

(73) Assignee: PANASONIC CORPORATION, Osaka (JP)

(21) Appl. No.: 13/783,731

(22) Filed: Mar. 4, 2013

(30) Foreign Application Priority Data
Sep. 26, 2012 (JP) 2012-212731

(51) Int. Cl. H04M 1/02

(52) U.S. Cl. CPC H04M 1/026
USPC 455/556.1

(57) ABSTRACT

A communication equipment includes a conductor element, a capacitive proximity detection sensor circuit, and a wireless communication circuit. The capacitive proximity detection sensor circuit processes a capacitance detection signal that the conductor element transmits or receives, and the wireless communication circuit processes a wireless signal that the conductor element transmits or receives.

### BACKGROUND OF THE DISCLOSURE

1. Field of the Disclosure

This disclosure relates to communication equipment including both a capacitive proximity detection sensor and an antenna element, and electronic equipment including the communication equipment.

2. Description of the Related Art

In recent years, wireless services of portable telephones and the like are widely popularized, and devised usage patterns of the communication equipment include intimate attachment, wearing and the like of the equipment on human bodies. Conventionally, there has been a concern about the influence of the communication equipment that emits electromagnetic waves on living bodies, and legal regulations are enforced on a specific absorption rate (SAR) for designated objective equipment of the wireless apparatuses in countries all over the world. In this case, for example, a local SAR is defined as 2.0 W/kg (10 g average) in Japan and Europe, and defined as 1.6 W/kg (1 g average) in the United States. Moreover, the regulations are being tightened in a manner similar to that of the case where the objective parts, which have been limited to the human head portion at first, are expanded to other human body portions.

In order to solve the aforementioned problem, a method of mounting a proximity detection sensor to detect a human body on the communication equipment and controlling the transmitting output of the communication module is devised. In this case, the proximity detection sensor to detect the capacitance value of the electrode has such an advantageous that the range of the extended sensor electrode can be widely detected.

As a method of controlling the transmitting output of the communication module, it is disclosed that an electronic device of, for example, a portable electronic device is configured to include an antenna and a relevant wireless communication circuit, and the proximity detection sensor is used for detecting that the electronic device is proximate to the user's head portion (See, for example, a Non-Patent Document 1). In this case, a control circuit inside the electronic device is used for adjusting the high-frequency signal transmitting power level. The high-frequency signal transmitting power level is reduced when it is judged that the electronic device exists within a predetermined distance from the user's head portion, or the limitation based on the proximity to the high-frequency signal transmitting power level is cancelled when it is judged that the electronic device does not exist within the predetermined distance from the user's head portion. Moreover, data from the proximity detection sensor is collected from a touch sensor, an accelerometer, an ambient light sensor and other data sources to be utilized for determining the adjustment method of the transmitting power level.

Moreover, as described above, a variety of capacitive proximity detection sensors are proposed as proximity detection sensors to detect a human body for the communication equipment (See, for example, a Non-Patent Document 2).

The patent documents related to the disclosure are as follows:
Patent Document 1: Japanese patent laid-open publication No. JP 2011-526099 A; and
Patent Document 2: Japanese patent laid-open publication No. JP 07-029467 A.

### SUMMARY OF THE DISCLOSURE

An object of the disclosure is to provide communication equipment that achieves a stable antenna performance by space saving.

According to one aspect of the disclosure, there is provided a communication equipment includes a conductor element, a capacitive proximity detection sensor circuit, and a wireless communication circuit. The capacitive proximity detection sensor circuit processes a capacitance detection signal that the conductor element transmits or receives, and the wireless communication circuit processes a wireless signal that the conductor element transmits or receives.

The disclosure is effective for achieving a stable antenna performance by space saving.

### BRIEF DESCRIPTION OF THE DRAWINGS

These and other objects and features of the disclosure will become clear from the following description taken in conjunction with the embodiments thereof with reference to the accompanying drawings throughout which like parts are designated by like reference numerals, and in which:

FIG. 1 is a block diagram showing a configuration of a proximity detection antenna apparatus according to a first embodiment;

FIG. 2 is a circuit diagram showing a configuration of one example of a capacitive proximity detection sensor circuit 2 of FIG. 1;

FIG. 3 is a graph showing a signal voltage generated from the capacitive proximity detection sensor circuit 2 of FIG. 2;

FIG. 4 is graph showing a detection voltage detected by the capacitive proximity detection sensor circuit 2 of FIG. 2;

FIG. 5 is a block diagram showing a configuration of a proximity detection antenna apparatus according to a second embodiment;

FIG. 6 is a block diagram showing a configuration of a proximity detection antenna apparatus according to a third embodiment;

FIG. 7 is a perspective view showing an external appearance of a computer 100 having the proximity detection antenna apparatus of the first to third embodiments; and

FIG. 8 is a perspective view showing an upper lid upper portion 101 where dielectric substrates 13 and 14 having the conductor element 1 of the proximity detection antenna apparatus are arranged in the computer 100 of FIG. 7.

### DETAILED DESCRIPTION OF THE EMBODIMENTS

Embodiments will be described in detail below with arbitrary reference to the drawings. It is noted that detailed description more than necessary is sometimes omitted. For example, it is sometimes the case where detailed description of already well-known matters and overlapped description of substantially identical configurations are omitted. This intends to prevent the following description from becoming needlessly redundant, and help easy understanding of those skilled in the art.

The present applicant provides the accompanying drawings and the following description for sufficient understanding of the disclosure by those skilled in the art, and does not intend to limit the subjects described in the claims for patent by them.

### First Embodiment

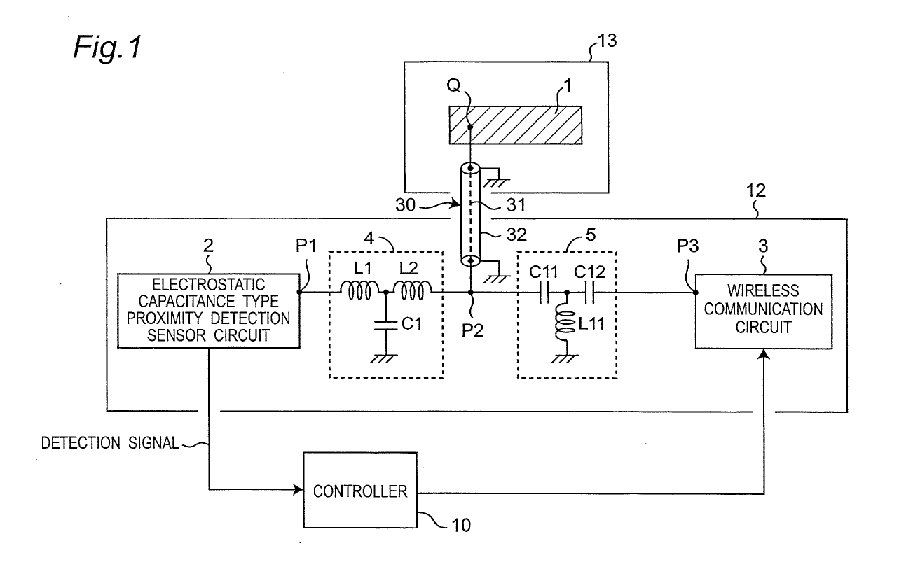

FIG. 1 is a block diagram showing a configuration of communication equipment according to the first embodiment. Referring to FIG. 1, the communication equipment of the first embodiment is provided as a module to achieve a communication function in electronic equipment of, for example, a personal computer, a portable telephone or the like. A well-known capacitive proximity detection sensor circuit 2, a wireless communication circuit 3 to transmit and receive wireless signals, a high-pass filter 5, and a low-pass filter 4 are formed on a dielectric substrate 12. Moreover, a conductor element 1, which concurrently serves as a capacitance detection element for the capacitive proximity detection sensor circuit 2, and an antenna element for the wireless communication circuit 3, is formed on a dielectric substrate 13. The conductor element 1 is configured to be not short-circuited to the ground. With this arrangement, the conductor element 1 operates to resonate as a non-short-circuit radiating element belonging to a monopole antenna in a desired wireless band of the communication equipment. Moreover, with this arrangement, the conductor element 1 has a capacitance value necessary for detecting the proximity of a human body. Moreover, the dielectric substrate 13 and the conductor element 1 can be formed of a flexible cable (FPC) or sheet metal molding or metal plating on a resin substrate.

The low-pass filter 4 is a T type filter configured to include, for example, two inductors L1 and L2, and a capacitor C1. The high-pass filter 5 is a T type filter configured to include, for example, two capacitors C11 and C12, and an inductor L11. The electrostatic capacitance components owned by the filters 4 and 5 with respect to the ground influence the proximity detection sensor performance. Therefore, the electrostatic capacitance components owned by the filters 4 and 5 with respect to the ground should beneficially be designed so that, for example, (C1+C11) is equal to or smaller than several tens of pico-farads. The cutoff frequency of the low-pass filter 4 is set smaller than the cutoff frequency of the high-pass filter 5. The low-pass filter 4 allows the burst signal and DC component for capacitance detection from the capacitive proximity detection sensor circuit 2 described later to pass therethrough. The burst signal is, for example, a signal of several hundreds of kilo-hertz and is able to pass through the low-pass filter 4. The low-pass filter 4 is designed so that the wireless signal processed by the wireless communication circuit 3 cannot pass therethrough. The wireless signal is, for example, a signal of several mega-hertz. The high-pass filter 5 allows the wireless signal processed by the wireless communication circuit 3 to pass therethrough. The high-pass filter 5 is designed so that the burst signal from the capacitive proximity detection sensor circuit 2 cannot pass therethrough. It is noted that the signal for capacitance detection issued by the capacitive proximity detection sensor circuit 2 is not limited to the burst signal, and a well-known low-frequency analog signal can be utilized.

A connection point P1 (detection terminal) of the capacitive proximity detection sensor circuit 2 is connected to a connection point P2 via the low-pass filter 4. On the other hand, a connection point P3 (input/output terminal) of the wireless communication circuit 3 is connected to the connection point P2 via the high-pass filter 5. The connection point P2 is connected to a feeding point Q at the conductor element 1. A coaxial cable (also referred to as a shield cable) having a characteristic impedance of, for example, 50Ω is used for the connection of the connection point P2 with the feeding point Q. In concrete, the connection point P2 is connected to the feeding point Q via an internal conductor 31 at the coaxial cable 30. The coaxial cable 30 is configured to include the internal conductor 31 and an outer conductor 32. The outer conductor 32 has its both ends grounded. The coaxial cable 30 can perform transmission with low loss when handling the wireless signal. In the coaxial cable 30, an electrostatic capacitance value between the inner conductor and the outer conductor can be regulated constant (e.g., 100 pF/m), and therefore, they can be both designed without receiving the influences of external turbulences.

The connection point P3 of the wireless communication circuit 3 is connected to the conductor element 1 via the high-pass filter 5 and the coaxial cable 30. The wireless communication circuit 3 receives the wireless signal received by the conductor element 1, and performs signal processing of demodulation and so on. Moreover, the wireless communication circuit 3 performs processing to generate a wireless signal that the conductor element 1 should transmit by modulating a baseband signal.

The capacitive proximity detection sensor circuit 2 generates a burst signal of several hundreds of kilo-hertz in a predetermined period. The capacitive proximity detection sensor circuit 2 transmits the burst signal to the conductor element 1 that opposite side as a capacitance detection element. The conductor element is electrically charged upon receiving the burst signal. The capacitive proximity detection sensor circuit 2 detects a capacitance value from the charged state of the conductor element 1. In concrete, the capacitive proximity detection sensor circuit 2 detects the voltage of a feedback signal detected at the connection point P1. It is noted that the capacitance detection signal in the present disclosure includes the burst signal, and includes the feedback signal. The capacitive proximity detection sensor circuit 2 detects a capacitance at the conductor element 1 on the basis of the voltage of the feedback signal. The capacitive proximity detection sensor circuit 2 performs the detection by judging whether or not a human body is proximate within a predetermined threshold distance from the conductor element 1 by hardware processing on the basis of the detected capacitance. The capacitive proximity detection sensor circuit 2 generates a predetermined detection signal when detecting the proximity of a human body, and transmits the signal to the controller 10. Upon receiving the predetermined detection signal, the controller 10 controls the wireless communication circuit 3 to reduce the transmitting power of the wireless signal to be transmitted and the like. It is noted that the function to judge whether a human body is proximate on the basis of the capacitance value may be owned by the controller 10 itself or the wireless communication circuit 3. In concrete, it is acceptable to obtain a capacitance value or a predetermined voltage value from the capacitive proximity detection sensor circuit 2 by the controller 10, and judge whether the human body is proximate on the basis of a threshold value held by the controller 10 by software processing. Otherwise, it is acceptable to simply transmit the capacitance value to the wireless communication circuit 3 by the controller 10 and judge whether or not a human body is proximate by the wireless communication circuit 3.

In the communication equipment of the first embodiment as configured as above, the connection point P1 serving as a detection electrode is connected to the conductor element 1 in terms of direct current. A signal line utilized for the connection is configured by being connected to the conductor element 1 via the low-pass filter 4 and the coaxial cable 30. In this case, by designing with the total value of the parasitic capacitances owned by the conductor element 1, the coaxial cable 30, the filter 4 and the filter 5 suppressed, deterioration in the sensor detection distance can be suppressed. In concrete, the total value of the parasitic capacitances should be beneficially designed within a range of the capacitance value necessary for driving the capacitive proximity detection sensor circuit 2. In order to reduce the total value of the parasitic capacitances, it is beneficial to arrange the conductor element 1, the coaxial cable 30, the filter 4 and the filter 5 close to one another. Moreover, the connection point P2 can be made compatible by connection each with characteristic impedance (e.g., 50Ω) without influence on the wireless signal. With this arrangement, a capacitance detection electrode and a wireless signal transceiving element can be configured to include the identical conductor element 1, and output control of a high-frequency wireless signal can be achieved by the controller 10 on the basis of the detection signal from the capacitive proximity detection sensor circuit 2.

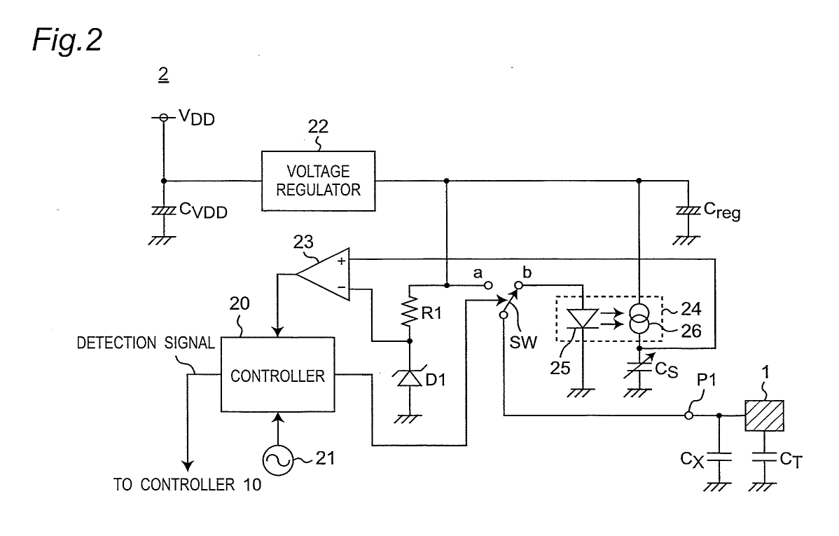

FIG. 2 is a circuit diagram showing a configuration of one example of the capacitive proximity detection sensor circuit 2 of FIG. 1. Referring to FIG. 2, the capacitive proximity detection sensor circuit 2 has a controller 20 for controlling the operation of the circuit, a clock generator 21, a voltage regulator 22, a comparator 23, a constant-voltage diode D1, a resistor R1, a switch SW, a current mirror circuit 24 that includes a diode 25 and a current source 26, a sampling capacitor Cₛₛ, electrolytic capacitors C_{VDD} and C_{reg}, and a connection point P1 that serves as a capacitance detection electrode. In FIG. 2, C_{X} is a floating capacitance between the conductor element 1 and the connection point P1, and C_{T} is a capacitance generated when the conductor element 1 is put in contact with a human finger or proximate to a human body.

The voltage regulator 22 converts an inputted power voltage V_{DD} into a predetermined operating voltage. The voltage converted by the voltage regulator 22 is converted into a reference voltage set by the constant-voltage diode D1 via the resistor R1, inputted to the inverted input terminal of the comparator, and inputted to the diode 25. In the current mirror circuit 24, a current proportional to the current flowing through the diode 25 flows from the current source 26 to the sampling capacitor C_{S}.

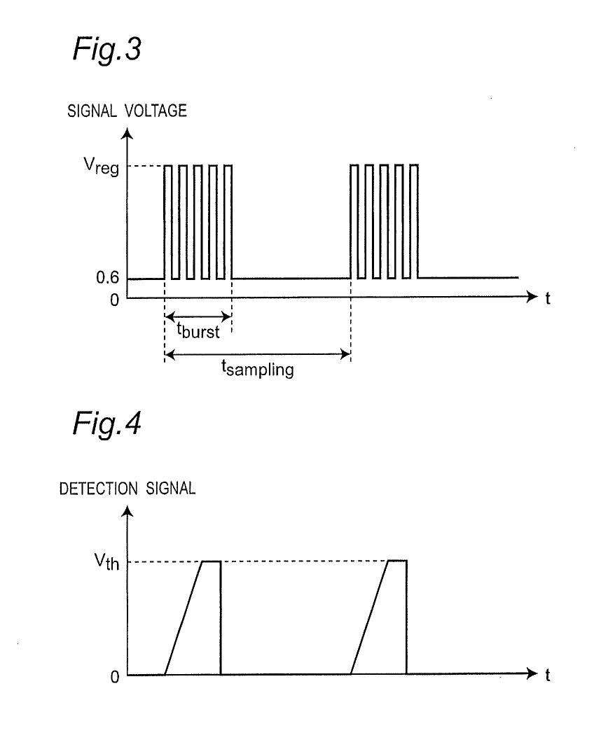

FIG. 3 is a graph showing a signal voltage generated from the capacitive proximity detection sensor circuit 2 of FIG. 2. FIG. 4 is a graph showing a detection voltage detected by the capacitive proximity detection sensor circuit 2 of FIG. 2. The operation of the capacitive proximity detection sensor circuit 2 of FIG. 2 is described with reference to FIGS. 2 to 4.

The controller 20 first switches the switch SW over to the contact point “a” side. When the switch SW is switched over to the contact point “a” side, a burst signal having a burst interval t_{burst} of, for example, about several hundreds of kilo-hertz is generated in a sampling period t_{sampling} of, for example, about 10 to 1000 milli-seconds as shown in FIG. 3, and is applied from the connection point P1 to the conductor element 1. When the burst signal is applied, the conductor element 1 is charged to have a predetermined voltage. The controller 20 switches the switch SW over to the contact point “b” side in the interval between the burst signals. When the switch SW is switched over to the contact point “b” side, a charging voltage is duplicated to the sampling capacitor Cₛ via the current mirror circuit 24. The controller 20 judges whether a human body has been detected according to whether or not the detection voltage exceeds a predetermined threshold voltage Vₜₕ as shown in for example, FIG. 4 by comparing the sampling capacitors Cₛ with a predetermined reference voltage by the comparator 23. When a human body is detected, the controller 20 outputs a detection signal to the controller 10. The above processing is periodically repeated in the aforementioned sampling period t_{sampling}.

As described above, according to the present embodiment, it is possible to obviate the need for separately providing the antenna element for wireless communications and the capacitive proximity detection sensor electrode for detecting a human body by sharing them. With this arrangement, it is not necessary to consider the deterioration of the antenna performance due to the proximity of the proximity detection sensor electrode to the antenna element for wireless signal transceiving, and in addition, the peripheries of the antenna element can be uniformly made a human body detection area. Moreover, transmitting power control of the wireless signal as a measure against SAR can be performed with high accuracy.

### Second Embodiment

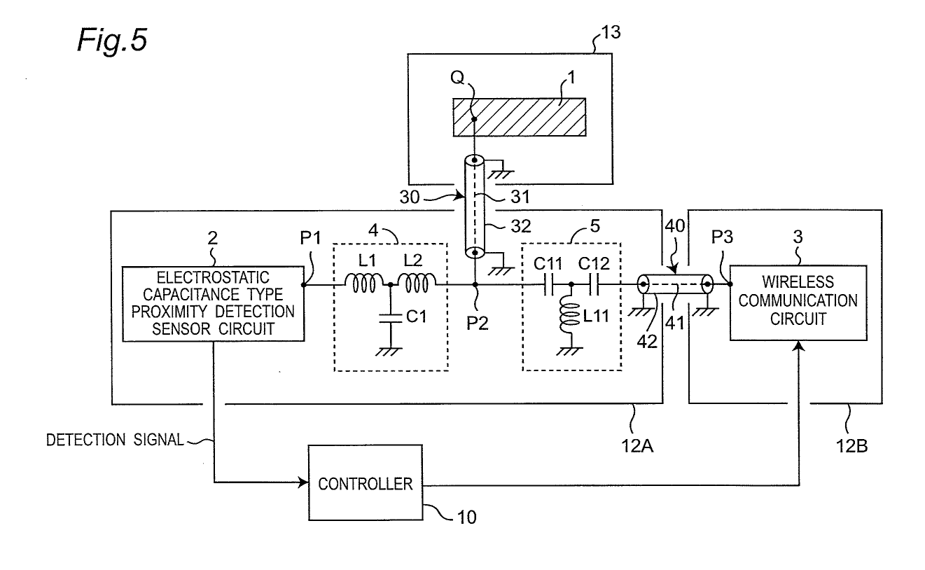

FIG. 5 is a block diagram showing a configuration of a proximity detection antenna apparatus according to the second embodiment. The proximity detection antenna apparatus of the second embodiment of FIG. 5 differs from the proximity detection antenna apparatus of the first embodiment of FIG. 1 in the following points.

(1) The dielectric substrate 12 is divided into two dielectric substrates 12A and 12B. The capacitive proximity detection sensor circuit 2, the low-pass filter 4 and the high-pass filter 5 are formed on the dielectric substrate 12A, while the wireless communication circuit 3 is formed on the dielectric substrate 12B.

(2) The connection point P3 of the wireless communication circuit 3 is connected to the high-pass filter 5 via the internal conductor 41 of a coaxial cable 40 having a characteristic impedance of, for example, 50Ω. In this case, the coaxial cable 40 is configured to include the internal conductor 41 and an outer conductor 42, and the outer conductor 42 is grounded at its both ends.

The second embodiment as configured as above has operational effects similar to those of the first embodiment. In addition, when the dielectric substrate 12B of the wireless communication circuit 3 is provided isolated from the dielectric substrate 12A of the capacitive proximity detection sensor circuit 2, the wireless communication circuit 3 can be connected to the conductor element 1 by connecting the dielectric substrates 12A and 12B using the coaxial cable 40. With this arrangement, the module unit for communications can be configured to be independent of the others while the parasitic capacitance values of the conductor element 1, the coaxial cable 30, the filter 4 and the filter 5 maintained low. Therefore, the module for communications can easily be integrated with the proximity detection sensor function combined with the antenna function for the equipment having the existing configuration.

### Third Embodiment

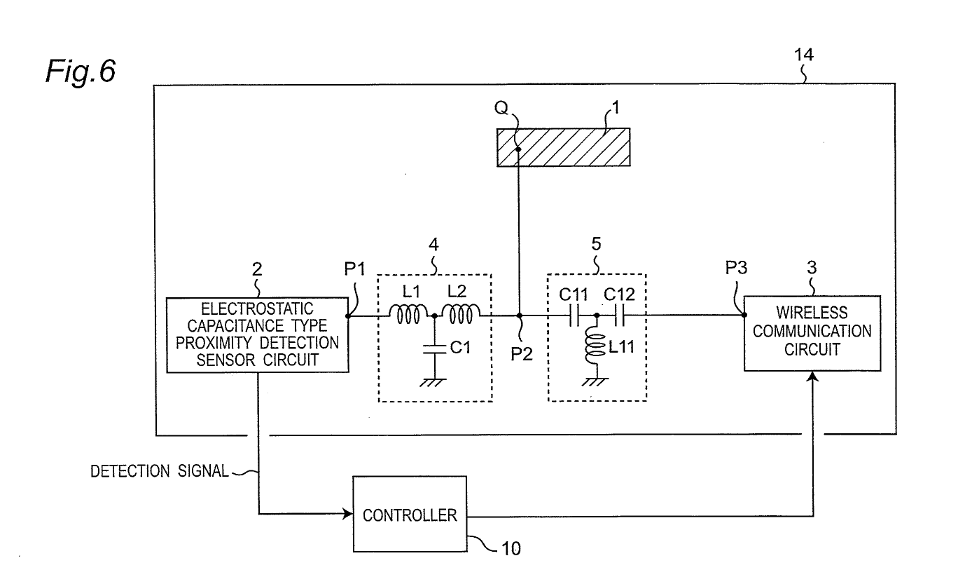

FIG. 6 is a block diagram showing a configuration of a proximity detection antenna apparatus according to the third embodiment. The proximity detection antenna apparatus of the third embodiment of FIG. 6 differs from the proximity detection antenna apparatus of the first embodiment of FIG. 1 in the following points.

(1) Two dielectric substrates 12 and 13 are each made of one dielectric substrate 14.

(2) With this arrangement, the conductor element 1, the capacitive proximity detection sensor circuit 2, the wireless communication circuit 3, the low-pass filter 4 and the high-pass filter 5 are formed on the one dielectric substrate 14.

The third embodiment as configured as above has operational effects similar to those of the first embodiment. In addition, the conductor element 1, the capacitive proximity detection sensor circuit 2, the wireless communication circuit 3, the low-pass filter 4 and the high-pass filter 5 can be formed on the one dielectric substrate 14. This arrangement can contribute to the compactification of the entire apparatus. In the third embodiment, the conductor element 1 can be connected with P2 on the substrate. Therefore, the conductor element 1 can be connected with P2 by the general connecting method of connection from on the substrate with the antenna for wireless communications of, for example, bringing a spring-shaped terminal in contact.

### Other Embodiments

As described above, the first to third embodiments have been described as exemplifications of mounting in the disclosure. However, the disclosure is not limited to this, and is also applicable to embodiments that are arbitrarily subjected to alteration, replacement, addition, omission and so on. Moreover, it is also possible to provide a new embodiment by combining the constituent elements described in the first to third embodiments. Accordingly, other embodiments are collectively described below.

Although the low-pass filter 4 and the high-pass filter 5 are inserted between the capacitive proximity detection sensor circuit 2 and the wireless communication circuit 3 in the aforementioned embodiments, the disclosure is not limited to this. The low-pass filter 4 may be not inserted between the capacitive proximity detection sensor circuit 2 and the wireless communication circuit 3 but provided inside the capacitive proximity detection sensor circuit 2. Moreover, it is sometimes the case where the low-pass filter 4 needs not be provided depending on the characteristics of the circuit 2. However, it is beneficial to insert the low-pass filter 4 between the capacitive proximity detection sensor circuit 2 and the wireless communication circuit 3, when the possibility of the transmission of the wireless signal to the capacitive proximity detection sensor circuit 2 decreases. Likewise, the high-pass filter 5 may not be inserted between the capacitive proximity detection sensor circuit 2 and the wireless communication circuit 3 but provided inside the wireless communication circuit 3. Moreover, it is sometimes the case where the high-pass filter 5 needs not be provided depending on the characteristics of the circuit 3. However, it is beneficial to insert the high-pass filter 5 between the capacitive proximity detection sensor circuit 2 and the wireless communication circuit 3, when the possibility of the transmission of the capacity detection signal to the wireless communication circuit 3 decreases. In this case, the low-pass filter 4 may be a low-pass filter whose transmission coefficient S21 is equal to or larger than a predetermined value of, for example, −3 dB with the maximum transmission level served as a criterion in a frequency band lower than a predetermined cutoff frequency. Moreover, the high-pass filter 5 may be a high-pass filter whose transmission coefficient S21 is equal to or larger than a predetermined value of, for example, −3 dB with the maximum transmission level served as a criterion in a frequency band higher than a predetermined cutoff frequency.

Although the coaxial cables 30 and 40 each of a shield cable are used in the aforementioned embodiments, the disclosure is not limited to this, and a transmission line such as a micro-strip line may be used.

Although one example of the capacitive proximity detection sensor circuit 2 is shown in FIG. 2 in the aforementioned embodiments, the disclosure is not limited to this, and a capacitive proximity detection sensor circuit of another circuit may be used.

Although the high-pass filter 5 to pass the wireless signal is used in the aforementioned embodiments, the disclosure is not limited to this, and a filter such as a band-pass filter that does not pass the burst signal but passes a wireless signal may be used.

Although the low-pass filter 4 that passes the capacitance detection signal and the DC component in the aforementioned embodiments, the disclosure is not limited to this, and another filter that passes the capacitance detection signal and the DC component may be used.

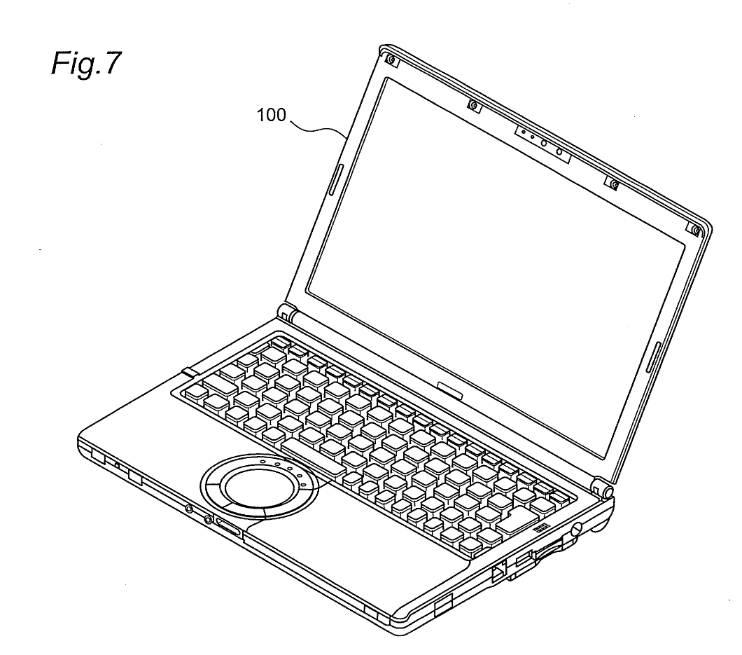

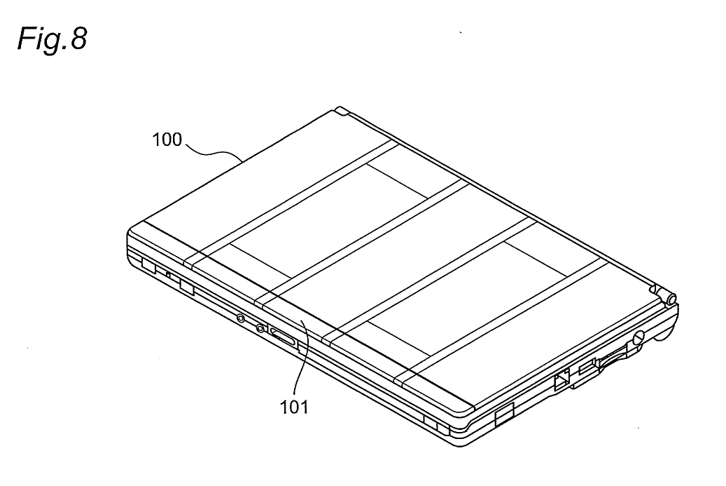

In the aforementioned embodiments, the communication equipment is provided, for example, inside electronic equipment such as the personal computer 100 of FIGS. 7 and 8 or a portable telephone. In this case, the dielectric substrates 13 and 14, which have the conductor element 1 of the proximity detection antenna apparatus, are provided inside the upper lid upper portion 101 of the computer 100 as shown in FIG. 8.

As described above, the embodiments that the applicant considers to be the best mode and other embodiments have been provided with the accompanying drawings and the detailed explanation. They are provided for those skilled in the art to exemplify the subjects described in the claims for patent with reference to the specific embodiments. Therefore, not only the constituent elements indispensable for solving the problems but also other components may be included in the constituent elements described in the accompanying drawings and the detailed description. Therefore, the fact that the dispensable constituent elements are described in the accompanying drawings and the detailed description should not always follow that the dispensable constituent elements are indispensable. Moreover, the aforementioned embodiments can be subjected to a variety of alterations, replacements, additions, omissions and so on within the scope of the claims for patent or a scope equivalent to it.

The disclosure is applicable to electronic equipment having communication equipment that achieves a stable antenna performance in a space-saving manner.

Although the disclosure has been fully described in connection with the embodiments thereof with reference to the accompanying drawings, it is to be noted that various changes and modifications are apparent to those skilled in the art. Such changes and modifications are to be understood as included within the scope of the disclosure as defined by the appended claims unless they depart therefrom.

What is claimed is:

1. A communication equipment comprising:
a conductor element;
a capacitive proximity detection sensor circuit configured to process a capacitance detection signal that the conductor element transmits or receives; and
a wireless communication circuit configured to process a wireless signal that the conductor element transmits or receives.

2. The communication equipment as claimed in claim 1, further comprising a first filter connected between the conductor element and the capacitive proximity detection sensor circuit.

3. The communication equipment as claimed in claim 2,
wherein the first filter is a low-pass filter whose transmission coefficient S21 is equal to or larger than a predetermined value in a frequency band lower than a predetermined frequency.

4. The communication equipment as claimed in claim 3,
wherein the first filter passes the capacitance detection signal therethrough.

5. The communication equipment as claimed in claim 1, further comprising a second filter connected between the conductor element and the wireless communication circuit.

6. The communication equipment as claimed in claim 5,
wherein the second filter is a high-pass filter whose transmission coefficient S21 is equal to or larger than a predetermined value in a frequency band higher than a predetermined frequency.

7. The communication equipment as claimed in claim 5,
wherein the second filter passes the wireless signal.

8. The communication equipment as claimed in claim 1, further comprising:
a first filter connected between the conductor element and the capacitive proximity detection sensor circuit; and
a second filter connected between the conductor element and the wireless communication circuit.

9. The communication equipment as claimed in claim 8,
wherein the first filter is a low-pass filter whose transmission coefficient S21 is equal to or larger than a predetermined value in a frequency band lower than a predetermined frequency, and
wherein the second filter is a high-pass filter whose transmission coefficient S21 is equal to or larger than a predetermined value in a frequency band higher than a predetermined frequency.

10. The communication equipment as claimed in claim 9,
wherein the first filter passes the capacitance detection signal therethrough, and
wherein the second filter passes the wireless signal therethrough.

11. The communication equipment as claimed in claim 1, further comprising a first transmission line configured to connect a connection point between the capacitive proximity detection sensor circuit and the wireless communication circuit with the conductor element.

12. The communication equipment as claimed in claim 11,
wherein the first transmission line is one of a coaxial cable and a micro-strip line.

13. The communication equipment as claimed in claim 5, further comprising a second transmission line to connect the wireless communication circuit with the second filter.

14. The communication equipment as claimed in claim 13,
wherein the second transmission line is a coaxial cable or a micro-strip line.

15. The communication equipment as claimed in claim 1,
wherein the capacitive proximity detection sensor circuit generates a detection signal when a human body is detected by the capacitance detection, and
wherein the equipment further comprises a controller configured to reduce a transmitting power of the wireless signal on the basis of the detection signal.

16. The communication equipment as claimed in claim 1,
wherein the capacitive proximity detection sensor circuit generates a detection signal by the capacitance detection, and
wherein the equipment further comprises a controller configured to reduce a transmitting power of the wireless signal when a human body is detected on the basis of the detection signal.

17. An electronic equipment comprising a communication equipment,
wherein the communication equipment comprising:
a conductor element;
a capacitive proximity detection sensor circuit configured to process a capacitance detection signal that the conductor element transmits or receives; and
a wireless communication circuit configured to process a wireless signal that the conductor element transmits or receives.
